(19) United States
(12) Patent Application Publication
(10) Pub. No.: US 2025/0257293 A1
(43) Pub. Date: Aug. 14, 2025

(54) CARE PRODUCT COMPOSITIONS HAVING IMPROVED OLFACTORY PROPERTIES

(71) Applicant: CALYXIA, BONNEUIL-SUR-MARNE (FR)

(72) Inventors: Damien DEMOULIN, BONNEUIL SUR MARNE (FR); Dounia ARCENS, BONNEUIL SUR MARNE (FR); Jamie WALTERS, BONNEUIL SUR MARNE (FR); Franco MANFRE, BONNEUIL SUR MARNE (FR)

(73) Assignee: CALYXIA, BONNEUIL-SUR-MARNE (FR)

(21) Appl. No.: 19/098,354

(22) Filed: Apr. 2, 2025

Related U.S. Application Data
(63) Continuation of application No. 17/425,109, filed on Jul. 22, 2021, now abandoned.

(30) Foreign Application Priority Data
Jan. 22, 2019 (FR) 1900538

(51) Int. Cl. C11D 3/50; B01J 13/16; C11D 17/00

(52) U.S. Cl. CPC C11D 3/507; B01J 13/16; C11D 17/003

(57) ABSTRACT

The present invention relates to a composition comprising: at least one composition for home care, and at least one solid microcapsule having an average diameter of between 1 μm and 30 μm, comprising a core consisting of a composition C1 comprising at least one perfuming agent, and a solid shell of crosslinked polymer totally encapsulating the core at its periphery, said solid shell comprising a crosslinked polymer obtained by polymerization of at least one monomer or polymer bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions, and wherein the thickness of the soli shell is between 0.1 μm and 20 μm.

### CROSS REFERENCE TO RELATED APPLICATIONS

The present application is a Continuation Application of U.S. Application No. 17/425, 109 filed Jul. 22, 2021, which is a U.S. National Phase Application under 35 U.S.C. § 371 of International Patent Application No. PCT/EP2020/051522 filed Jan. 22, 2020, which claims priority of French Patent Application No. 19 00538 filed Jan. 22, 2019. The entire contents of which are hereby incorporated by reference.

### FIELD OF THE INVENTION

The subject of the present invention concerns compositions intended in particular for detergency, home care cleaning, comprising microcapsules and having improved olfactory properties.

### BACKGROUND

Fragrance is one of the leading factors at the present time for the purchase of cleaning products such as household cleaners. The sensorial characteristics appreciated by consumers are a pleasant, fresh smell dispensed by the product in persistent and long-lasting manner.

Reaching this level of olfactory performance is a true technological challenge for players in this sector. First, fragrances are volatiles substances which tend to evaporate rapidly in the cleaning product bottle before being able to dispense a pleasant smell on use. Secondly, it is ascertained that since fragrances are mostly hydrophobic substances, they scarcely adhere to surfaces on account of the surfactants also contained in cleaning products. A large part of the fragrance contained in a cleaning product is therefore lost either by evaporation or through removal by surfactants without being able to attach to surfaces leaving a fragrance.

To overcome this problem, a major innovation emerged in the years 2000 with microcapsules of fragrance. The benefit brought by the polymer shell encapsulating the fragrance in a microcapsule is multiple. First, the polymer shell allows limiting of fragrance evaporation rate. Also, the affinity of the polymer shell for the constituent materials of surfaces to be treated enables the microcapsules and hence the fragrance to attach thereto. Finally, the microcapsules provide a long-lasting perfuming effect by progressively diffusing the fragrance they contain or by progressively rupturing on mechanical contact with the surface for gradual release of the fragrance.

Microcapsules have therefore allowed an improvement in the olfactory performance of cleaning products whilst reducing the amount of fragrance contained in these products and hence the cost thereof. However, manufacturers are now faced with increasingly tighter environmental restrictions and seek to make their products biodegradable. Current microcapsules, sourced from non-biodegradable plastics are a major impediment to this dynamic.

The microcapsules chiefly used in cleaning products are produced by emulsion interfacial polymerization of a compound in the formaldehyde family with a compound in the melamine family. Such compositions of cleaning products are detailed in particular in applications US 2013/0203642, U.S. pat. No. 7,119,057, WO 2015/031418, US 2015/0252312 and US 2016/177241. These capsules exhibit adequate performance in protecting the fragrance against evaporation and long-lasting perfuming but are not biodegradable.

Biodegradable alternatives have been developed, such as microcapsules of non-polymerized matrix type containing cellulose, polycaprolactone or polyvinylpyrrolidone, as described in particular in applications CN106614564 or US 2015/265541. These microcapsules are highly porous however, and the properties they could impart in terms of protection of fragrance against evaporation and perfuming are insufficient.

There is therefore a technical need for microcapsules which are biodegradable whilst improving the properties of long-lasting fragrance.

### SUMMARY

It is therefore the objective of the invention to provide a composition particularly intended for home cleaning, containing biodegradable microcapsules and allowing the dispensing of a long-lasting, pleasant fragrance.

A further objective of the present invention is to provide a detergency product dispensing a pleasant, long-lasting fragrance and exhibiting less fragrance evaporation compared with current products containing microcapsules.

A further objective of the invention is to provide a biodegradable detergency product dispensing a pleasant, long-lasting pleasant fragrance.

The present invention therefore concerns a composition comprising:
at least one composition for home care; and
at least one solid microcapsule having an average diameter of between 1 μm and 30 μm, comprising:
a core consisting of a composition C1 comprising at least one perfuming agent; and
a solid shell of a crosslinked polymer totally encapsulating the core at its periphery, said solid shell comprising a crosslinked polymer obtained by polymerization of at least one monomer or polymer bearing at least one reactive function selected from the group consisting of acrylate, methacrylate, vinyl ether, N-vinyl ether, epoxy, siloxane, amine, lactone, phosphate and carboxylate functions,

and wherein the thickness of the solid shell is between 0.1 μm and

20 μm, preferably between 0.2 μm and 8 μm, more preferably between 0.2 μm and 5 μm.

The present invention concerns a composition comprising:
at least one composition for home care; and
at least one solid microcapsule having an average diameter of between 1 μm and 30 μm, comprising:
   a core consisting of a composition C1 comprising at least one perfuming agent, said composition C1 being in the form of an emulsion; and
   a solid shell of a crosslinked polymer totally encapsulating the core at its periphery, said solid shell comprising a crosslinked polymer obtained by polymerization of at least one monomer or polymer bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions,

and wherein the thickness of the solid shell is between 0.1 μm and

20 μm, preferably between 0.2 μm and 8 μm, and more preferably between 0.2 μm and 5 μm.

Surprisingly, the inventors have ascertained that by associating a formula of a home care cleaning product such as a surface cleaner well known in the prior art with microcapsules of crosslinked polymers such as crosslinked polyesters, crosslinked polyepoxides or crosslinked polyurethanes, the resulting home cleaning product has the following properties:
it dispenses a pleasant, long-lasting fragrance;
it exhibits lesser evaporation of fragrance than products in the prior art containing microcapsules; and
it is biodegradable.

For the composition of the invention, a composition usually intended for home cleaning but not containing microcapsules as detailed below is combined with biodegradable microcapsules having a core containing a perfuming agent.

In the invention, the microcapsules do not comprise a home cleaning composition. In particular, the core of the microcapsules used in the invention does not comprise a surface cleaning composition or any detergent product.

The present invention particularly consists of using biodegradable microcapsules having a core containing a perfuming agent to improve the olfactory properties of compositions of home cleaning products.

In the present application, the terms «microcapsules» and «capsules» are used indifferently.

### Compositions for Home Cleaning

As indicated above, the compositions of the invention comprise a composition for home cleaning.

These compositions for home cleaning are selected from among compositions well known in the prior art intended for home care and cleaning, for example scouring agents, detergents for glass, neutral all-purpose cleaning agents, bathroom cleaning agents, washing agents, rinsing agents, dishwashing agents, kitchen cleaners, oven cleaners, dishwasher detergents, floor cleaners and detergents, window cleaning agents, ceramic cleaners, WC bowl cleaners, cleaners and shampoos for rugs and carpets, stain-resisting agents, furniture polish, products and waxes for polishing glass, wood, plastic, marble, granite, tiling, etc., products for polishing vehicle bodywork, leather treatment agents, vinyl treatment agents and air purifiers.

Preferably, these compositions do not comprise (micro) capsules.

In particular, the compositions for home cleaning are cleaning compositions in particular liquid cleaning compositions for surfaces.

Compositions for home cleaning can include surfactant compounds, in particular nonionic surfactant compounds.

The choice of surfactant compound (surfactant) and the amount thereof is dependent on the envisaged use of the home cleaning composition.

The total content of surfactant agent is also dependent on the final intended use and can reach 60 weight %. Typically, the compositions for home cleaning used in the present invention comprise at least 2 weight % of surfactant, preferably from 2% to 6%, in particular from 15% to 40% and preferably from 25% to 35% relative to the total weight of the composition.

In one embodiment, the composition for home cleaning used in the invention comprise at least one surfactant selected in particular from among anionic, cationic, nonionic, amphoteric and zwitterionic surfactants and mixtures thereof, in particular such as described in detail in the literature, for example in “Surface Active Agents and Detergents”, Volumes I and II, by Schwartz, Perry and Berch.

In one embodiment, the compositions for home cleaning used in the invention comprise at least one anionic surfactant selected in particular from among linear alkylbenzene sulfonates, in particular linear alkylbenzene sulfonates having an alkyl chain length of C8 to C16. Preferably the content of these surfactants is between 0 weight % and 40 weight %, in particular between 1 weight % and 25 weight %, and preferably between 2 weight % and 15 weight % relative to the total weight of said composition.

As anionic surfactants, mention can also be made of the alkaline salts of saturated or unsaturated fatty acids having 12 to 18 carbon atoms, the sulfuric acid semi-ester salts of fatty alcohols having 12 to 18 carbon atoms, and the sulfation products of the nonionic surfactants mentioned above having a low degree of ethoxylation; primary and secondary alkylsulfates in particular primary branched chain and statistical C8 to C15 alkylsulfates; C10 to C18 secondary (2,3) alkylsulfates; alkyl ether sulfates; sulfated fatty alcohol ethoxylates (FAE)s, preferably alkyl alkoxy sulfates; C10 to C18 alkyl alkoxy carboxylates; mid-chain branched alkylsulfates; mid-chain branched alkyl alkoxy sulfates; modified alkylbenzene sulfonates; methyl ester sulfonates; olefin sulfonates; alkyl xylene sulfonates; dialkyl sulfosuccinates; and fatty acid ester sulfonates. The sodium salts are generally preferred.

In one embodiment, the compositions for home cleaning used in the invention comprise at least one nonionic surfactant.

As nonionic surfactants, mention can be made for example of ethoxylates or propoxylates of alkylglycosides and/or of primary and secondary alcohols, in particular C8 to C20 ethoxylated aliphatic alcohols with an average of 1 to 20 moles of ethylene oxide per mole of alcohol, and C10 to C15 primary and secondary ethoxylated aliphatic alcohols; C6 to C12 alkoxylates of alkyl alkylphenol in which the alkoxylate repeating units are a mixture of ethyleneoxy and propyleneoxy units; C12 to C18 alcohol condensates and C6 to C12 alkylphenol condensates with ethylene oxide/propylene oxide block alkyl polyamine ethoxylates; alkylpolysaccharides; amides of polyhydroxylic fatty acids; and alkoxylated ester surfactants such as fatty methyl ester ethoxylates (MEEs).

As nonionic surfactants, mention can also be made for example of non-ethoxylated nonionic surfactants such as alkyl polyglycosides, glycerol monoethers and polyhydroxy amides (glucamide), the ethoxylation and/or propoxylation products of N-alkylamines, of vicinal diols, of fatty acid esters and of fatty acid amides.

Said surfactants can be included in these compositions in contents of between 0 and 40 weight %, preferably between 1 and 25 weight %, more preferably between 2 and 15 weight % relative to the total weight of said composition.

In one embodiment, the compositions for home cleaning used in the invention comprise at least one amphoteric surfactant.

As amphoteric surfactants, mention can be made for example of derivatives of secondary and tertiary amines, derivatives of heterocyclic secondary and tertiary amines; or the derivatives of quaternary ammonium, quaternary phosphonium or tertiary sulfonium compounds such as betaine, including alkyl dimethyl betaine and cocodimethylamidopropyl betaine, C8 to C18 amine oxides and sulfo-and hydroxybetaines such as N-alkyl-N, N-dimethylamino-1-propanesulfonate where an alkyl group can be C8 to C18 or C10 to C14; water-soluble amine oxides such as a C10 to C18 alkyl dimethyl amine oxide or C8 to C12 alkoxy ethyl dihydroxyethyl amine oxide.

In one embodiment, the compositions for home cleaning used in the invention comprise at least one stabilizing agent of which the main purpose is to suspend and stabilize the microcapsules.

As stabilizer, mention can be made of any known ingredient capable of suspending particles and/or of adjusting the rheology of a liquid composition, in particular crystalline materials containing a hydroxy group, polyacrylates, polycarboxylates, salts of alkali metals, salts of alkaline-earth metals, ammonium salts, alkanolammonium salts, C12 to C20 fatty alcohols, derivatives of di-benzylidene polyol acetate (DBPA), cationic polymers comprising a first structural unit derived from methacrylamide and a second structural unit derived from diallyldimethylammonium chloride, and a combination thereof. It is also possible to use C8 to C22 linear alcohols alkoxylated with 10 to 20 moles of alkylene oxide, C10 to C20 linear alcohols or mixtures thereof. Other stabilizing agents comprise deflocculating polymers such as described in EP 0 415 698 and EP 0 458 599. Advantageously, the nonionic stabilizing agent is a C8 to C222 linear alcohol alkoxylated with 10 to 20 moles of alkylene oxide. Gums and other polysaccharides can also be advantageously used e.g. gellan gum, carrageenan gum, xanthan gum, polyvinyl alcohol and derivatives thereof, cellulose and derivatives thereof including cellulose ethers and cellulose esters and tamarin gum (for example comprising xyloglucan polymers), guar gum, locust bean gum. Finally, mention can be made of fatty acids and fatty waxes e.g. C8 to C24 alkyl or alkenyl monocarboxylic acids or the polymers thereof, and castor oil and derivatives thereof. Preferably, saturated fatty acids are used, in particular C16 to C18 hardened tallow fatty acids. Preferably, the fatty acid is non-saponified, more preferably the fatty acid is free e.g. oleic acid, lauric acid or tallow fatty acid.

Said stabilizing agents can be included in these compositions in contents of between 0.1 and 10 weight %, in particular from 0.5 to 5 weight %, and preferably from 1 to 4 weight % relative to the total weight of the composition.

In one embodiment, the compositions for home cleaning used in the invention comprise at least one inorganic additive improving the detergence properties of the product, such as sodium carbonate optionally in combination with a seed crystal for calcium carbonate, crystalline and amorphous aluminosilicates such as zeolites, inorganic phosphates and polyphosphates such as sodium orthophosphate, pyrophosphate and tripolyphosphate.

Preferably, said inorganic additives are included in contents of between 5 and 40 weight % relative to the total weight of the composition.

In one embodiment, the compositions for home cleaning used in the invention comprise at least one organic detergent additive such as polycarboxylic acids, in particular citric acid, adipic acid, succinic acid, glutaric acid, malic acid, tartaric acid, malaric acid, fumaric acid and saccharic acids, monomer and polymer aminopolycarboxylic acids in particular methylglycinediacetic acid, nitrilotriacetic acid and ethylenediamine-tetraacetic acid and polyaspartic acid, polyphosphonic acids in particular aminotris acid (methylene phosphonic acid), ethylenediamine tetrakis compounds (methylene phosphonic acid) and polymeric acids such as dextrin (poly), polymer acrylic acids, methacrylic acids, maleic acids and their polymer mixtures. All the indicated acids are generally used in the form of their water-soluble salts, in particular the alkaline salts thereof.

Preferably, said organic detergent additives are included in contents of between 0.5 and 25 weight %, preferably 1 to 10 weight % relative to the total weight of the composition.

In one embodiment, the compositions for home cleaning used in the invention comprise at least one organic detergent additive of polycarboxylate monomer type such as citrates, gluconates, oxydisuccinates, glycerol mono-, di- and trisuccinates, carboxymethyloxy succinates, carboxymethyloxymalonates, dipicolinates, hydroxyethyl iminodiacetates, alkyl-and alkenylmalonates and the succinates and salts of sulfonated fatty acids.

Preferably, said organic detergent additives are included in contents of between 5 and 30 weight %, preferably from 10 to 25 weight % relative to the total weight of the composition.

In one embodiment, the compositions for home cleaning used in the invention comprise at least one peroxy bleach compound, e.g. inorganic persalts or organic peroxyacids capable of producing hydrogen peroxide in aqueous solution. Suitable peroxy bleaching compounds comprise organic peroxides such as urea peroxide and inorganic persalts such as perborates, percarbonates, perphosphates, persilicates and persulfates of alkali metals. Particular mention can be made of sodium perborate monohydrate and tetrahydrate, and sodium percarbonate, phthalimidoperoxycaproic acid, peroxybenzoic acid, hypohalite, peroxyacetic acid, diperoxoazelaic acid, diperoxododecanedioic acid and oxidizing enzyme systems or the salts of diperoxododecanedioic acid.

Preferably, said peroxy bleach compounds are included in contents of between 0.1 and 35 weight %, preferably from 0.5 to 25 weight % relative to the total weight of the composition.

In one embodiment, the compositions for home cleaning used in the invention comprise at least one bleach activator or precursor which can be used in conjunction with the bleach compound to improve bleaching action at low washing temperatures, such as complexes of catalytic metals, precursors of peroxycarboxylic acid, more particularly precursors of peracetic acid and the precursors of pernoanoic acid e.g. N,N,N′,N′-tetracetylethylenediamine (TAED), sodium nonanoyloxybenzene sulfonate (SNOBS), octanoyl caprolactam, benzoyloxybenzene sulfonate, nonanoyloxybenzene-sulfonate, benzoylvalerolactolactam, methyl dodecanobenzylacrylate. Also, a peroxyacid can be used such as imido peroxycarboxylic peracids, phthalimido peroxycaproic acid (PAP).

Preferably, said bleach activators or precursors are included in contents of between 0.1 and 8 weight %, preferably from 0.5 to 5 weight % relative to the total weight of the composition.

In one embodiment, the compositions for home cleaning used in the invention comprise at least one bleach stabilizer (transition metal sequestering agent) such as ethylenediaminetetraacetate (EDTA), polyphosphonates such as Dequest (registered trademark) and non-phosphate stabilizers such as EDDS (ethylene diamine di-succinic acid).

In one embodiment, the compositions for home cleaning used in the invention comprise at least one enzyme such as those in the protease class (subtilisins in particular), cutinases, amylases, pullulanases, hemicellulases, cellulases, hemicellulases, mannanases, pectin-separating enzymes, tannases, xylanases, xanthanases, β-glucosidases, carrageenases, perhydrolases, oxydases, oxydoreductases, lipases and peroxidases, and mixtures thereof. The active enzymatic substances obtained from fungi or bacteria such as Bacillus subtilis, Bacillus licheniformis, Streptomyces griseus, Humicola lanuginosa, Humicola insolens, Pseudomonas pseudoalcaligenes or Pseudomonas cepacia are particularly suitable. The enzymes optionally used can be adsorbed on substrate substances and/or incorporated in encapsulation substances for protection against early inactivation.

Preferably, said enzymes are included in contents of between about 0.1 to 3.0 weight % relative to the total weight of the composition.

In one embodiment, the compositions for home cleaning used in the invention comprise at least one powder structuring agent such as a fatty acid (or fatty acid soap), a sugar, an acrylate copolymer, or acrylate/maleate copolymer, or sodium silicate.

Preferably, said powder structuring agents are included in contents of 1 to 5 weight % relative to the total weight of the composition.

The compositions for home cleaning used in the invention may further comprise other additives such as dirt releasing polymers; inorganic salts such as sodium sulfate or sodium hydroxide; colorants; and uncoupling polymers.

In one embodiment, the compositions for home cleaning comprises at least one free perfuming agent i.e. non-encapsulated. Said perfuming agents are well known to persons skilled in the art and notably include those mentioned for example in S. Arctander, Perfume and Flavor Chemicals (Montclair, N.J., 1969), S. Arctander, Perfume and Flavor Materials of Natural Origin (Elizabeth, N.J., 1960), in the list of the International Fragrance Association (IFRA http://www.ifraorg.org/en/ingredients) and in “Flavor and Fragrance Materials”, 1991 (Allured Publishing Co. Wheaton, III. USA).

Preferably, said free perfuming agents are included in contents of 0.1 to 5 weight %, preferably from 0.2 to 3 weight %, more preferably from 0.3 to 2 weight % relative to the total weight of the composition.

In one embodiment, the compositions for home cleaning used in the invention comprise at least one defoamer such a silicone oil or paraffin.

Preferably, said defoamers are included in contents of 0.05 to 4 weight %, preferably from 0.1 to 3 weight %, and in particular from 0.2 to 1 weight % relative to the total weight of the composition.

In one embodiment, the compositions for home cleaning used in the invention comprise at least one degreasing agent or anti-redeposition agent such as nonionic cellulose ethers e.g. methylcellulose, carboxymethylcellulose, methylhydroxypropylcellulose, the polymers of phthalic acid and/or terephthalic acid, in particular ethylene terephthalate polymers and/or polyethyleneglycol terephthalates or the derivatives thereof with anionic and/or nonionic modification, and preferably in a content of between 0 and 5 weight % relative to the total weight of the composition.

In one embodiment, the compositions for home cleaning used in the invention comprise at least one optical brightener which can include any compound having fluorescence, including compounds absorbing and re-emitting UV light in the form of visible “blue” light. Said brighteners comprise: derivatives of stilbene, of 4,4′-diaminostilbene, of biphenyl, of distyrylbiphenyls, five-membered heterocycles such as triazoles, pyrazolines, oxazoles, imidiazoles, or six-membered heterocycles (such as coumarins, naphthalamides, s-triazines).

Preferably, said optical brighteners are included in contents of 0 to 0.4%, in particular from 0.1 to 0.3 weight % relative to the total weight of the composition.

In one embodiment, the compositions for home cleaning used in the invention comprise at least one non-aqueous solvent, such as monohydric or polyhydric alcohols, alkanolamines or glycol ethers provided that they are water-miscible within the specified concentration. Preferably, the solvents are selected from among ethanol, n-propanol, isopropanol, butanols, glycol, propanediol, butanediol, methylpropanediol, glycerol, diglycol, propyl diglycol, butyl diglycol, hexylene glycol, ethylene glycol, ethylene glycol and ethylene glycol, ethylene glycol propylene ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxy triglycol, ethoxy triglycol, butoxy triglycol, 1-butoxyethoxy-2-propanol, 3-methyl-3-methoxybutanol, propyleneglycol ether, t-butylether, di-n-octyl ether and mixtures of these solvents.

Preferably, said non-aqueous solvents are included in contents of 0 to 25 weight %, preferably 1 to 20 weight % and in particular 2 to15 weight % relative to the total weight of the composition.

In one embodiment the compositions for home cleaning used in the invention comprise water.

### Solid Microcapsules

As indicated above, the compositions of the invention comprise at least one solid microcapsule such as defined above.

Preferably, the compositions of the invention comprise several solid microcapsules i.e. a series or assembly of solid microcapsules all the same or differing.

The microcapsules of the invention are called solid microcapsules on account of the solid nature of the crosslinked polymer shell.

In one embodiment, the solid microcapsules of the invention comprise a liquid (non-solid) core.

The microcapsules used in the invention, considering the choice of specific monomers and polymers, have the property of being biodegradable.

Biodegradability is defined herein as the ability to degrade in a natural environment, such as defined in the OECD guidelines: OECD 301 (Ready Biodegradability), namely OECD 301 A (Dissolved Organic Carbon (DOC) Die-Away), OECD 301 B (CO₂ Evolution), OECD 301 C (Modified MITI Test (I)), OECD 301 D (Closed Bottle Test), OECD 301 E (Modified OECD Screening), OECD 301 F (Manometric Respirometry), or OECD 304A (Inherent Biodegradability in Soil), OECD 306 (Biodegradability in Seawater) and OECD 310 (Ready Biodegradability—CO₂ in sealed vessels (Headspace Test)).

The microcapsules of the invention are characterized in that they have a core comprising at least one perfuming agent, said perfuming agent differing from the composition for home cleaning.

In the invention, the above-mentioned composition for home cleaning and the solid microcapsules (series or assemblies of solid microcapsules) are different entities.

In one embodiment, the composition of the invention comprises an assembly of solid microcapsules, each of said solid microcapsules being such as defined above, and in which the standard deviation of diameter size distribution of the microcapsules is less than 50%, in particular less than 25% or less than 1 μm.

The size distribution of the solid microcapsules can be measured for example by image analysis technique under an optical microscope, or by light scattering technique using a Mastersizer 3000 (Malvern Instruments) equipped with a Hydro SV measurement cell.

Composition C1

As mentioned above, preferably composition C1 is in emulsion form and therefore comprises a continuous phase and a dispersed phase.

In one embodiment, composition C1 such as defined above in the core of the solid microcapsules comprises at least 20 weight % of perfuming agent relative to the total weight of said composition C1, preferably 25 to 60 weight % and more preferably 30 to 50 weight % relative to the total weight of said composition C1.

In one embodiment, composition C1 also comprises at least one gelling agent.

Said gelling agent can be selected from the group of water-soluble or water-dispersible polymers, aqueous in particular, preferably selected from the group composed of:
cellulose derivatives, such as ethers of cellulose: methyl cellulose, ethyl cellulose, hydroxyethyl cellulose, methylhydroxyethyl cellulose, ethylhydroxyethyl cellulose, carboxymethyl cellulose, hydroxypropyl cellulose or methylhydroxypropyl cellulose;
polyacrylates (also called carbomers), such as polyacrylic acid (PAA), polymethacrylic acid (PMAA), poly (hydroxyethyl methacrylate) (pHEMA), poly (N-2-hydroxypropyl methacrylate) (pHPMA);
polyacrylamides such as poly (N-isopropylacrylamide) (PNIPAM);
polyvinylpyrrolidone (PVP) and derivatives thereof;
polyvinyl alcohol (PVA) and derivatives thereof;
poly(ethylene glycol), poly(propylene glycol) and derivatives thereof such as poly(ethylene glycol) acrylate/methacrylate, poly(ethylene glycol) diacrylate/dimethacrylate, polypropylene carbonate;
polysaccharides such as carrageenans, locust bean gum or tara gum, dextran, xanthan gums, chitosan, agarose, hyaluronic acids, gellan gum, guar gum, gum arabica, gum tragacanth, diutan gum, oat gum, karaya gum, ghatti gum, curdlan gum, pectin, konjac gum, starch;
protein derivatives such as gelatine, collagen, fibrin, polylysine, albumin, casein;
polyurethanes and derivatives thereof.

Said gelling agent can also be selected from the group of solid particles such as clays, silicas and silicates that can be used as gelling agents when dispersed in water.

As solid particles able to be used in composition C1 as gelling agent, mention can be made of clays and silicates belonging in particular to the category of phyllosilicates (also called sheet silicas). As examples of silicates able to be used in the invention, mention can be made of Bentonite, Hectorite, Attapulgite, Sepiolite, Montmorillonite, Saponite, Sauconite, Nontronite, Kaolinite, Talc, Sepiolite, Chalk. Synthetic fumed silicas can also be used. The aforementioned clays, silicates and silicas can advantageously be modified by organic molecules such as polyethers, ethoxylated amides, quaternary ammonium salts, long chain diamines, long chain esters, polyethylene glycols, polypropylene glycols.

Preferably, said gelling agent is selected from the group composed of cellulose derivatives, polyacrylates, derivatives of poly (ethylene glycol) and synthetic silicas.

In one embodiment, composition C1 comprises between 0.1 and 30 weight % of gelling agent, preferably between 0.5 and 20 weight %, more preferably between 0.5 and 10 weight %.

In one embodiment, composition C1 comprises between 30 and 70 weight % of water, preferably between 35 and 65 weight % and more preferably between 35 and 60%.

In one embodiment, composition C1 also comprises at least one surfactant, selected in particular from among anionic, cationic, amphoteric and nonionic surfactants. As surfactants, mention can be made of block oxyethylene/oxypropylene polymers such as Poloxamers; sorbitan fatty acid esters and the oxyethylenated derivatives thereof such as sorbitan monostearate, sorbitan monopalmitate, oxyethylenated sorbitan stearates, palmitates and oleates; derivatives of polyethylene glycol and a mixture of glycerides (mono-, di- and tri-glycerides) of caprylic acid and capric acid; alkylpolyglycosides and in particular alkylpolyglucosides such as caprylyl/capryl glucoside or laurylglucoside.

In one embodiment, composition C1 also comprises at least one hydrophobicity correcting agent of the fragrance. These agents are hydrophobic materials having a cLogP higher than 4, preferably higher than 6, and having good miscibility with the fragrances used. Among these agents, mention can be made for example of oils of mono-, di and tri-glycerides such as capric/caprylic triglycerides; fatty acid esters of oligomers of polyglycerol, of polyethylene glycol, of polypropylene glycol and of polybutylene glycol; nonionic fatty alcohol alkoxylates such as isopropyl myristate, diethyl phthalate, dibutyl phthalate, diisodecyl adipate; mineral oils; silicone oils such as polydimethylsiloxane and polydimethylcyclosiloxane; diethyl phthalate; polyalphaolefins; castor oil.

Preferably, composition C1 is in nanoemulsion form in which the continuous phase is an aqueous gel. Preferably, the mean diameter of the droplets of said nanoemulsion is between 50 nm and 5 μm, preferably between 100 nm and 3 μm, and more preferably between 100 nm and 1 μm.

Preferably, composition C1 is in an emulsion form in which the continuous phase is an aqueous gel.

Preferably, the mean diameter of the droplets of said emulsion is between 50 nm and 5 μm, more preferably between 100 nm and 3 μm, and further preferably between 100 nm and 1 μm.

### Perfuming Agent

As mentioned above, composition C1 comprises at least one perfuming agent.

For example, composition C1 of the invention can comprise a single perfuming agent (single fragrance) or a mixture of several perfuming agents (or mixture of several fragrances).

Among the perfuming agents, particular mention can be made of any type of perfume or fragrance, these terms being used indifferently herein. These perfumes or fragrances are well known to those skilled in the art and particularly include those mentioned for example in S. Arctander, Perfume and Flavor Chemicals (Montclair, N.J., 1969), S. Arctander, Perfume and Flavor Materials of Natural Origin (Elizabeth, N.J., 1960), in the list of the International Fragrance Association (IFRA http://www.ifraorg.org/en/ingredients) and in “Flavor and Fragrance Materials”, 1991 (Allured Publishing Co. Wheaton, III. USA).

The fragrances used in the present invention may comprise natural products such as extracts, essential oils, absolutes, resinoids, resins, concretes, etc. . . . as well as the basic substances of synthesis such as hydrocarbons, alcohols, aldehydes, ketones, ethers, acids, esters, acetals, ketals, nitriles, etc. . . . , including saturated and unsaturated compounds, aliphatic, alicyclic and heterocyclic compounds.

In one embodiment, the perfuming agent comprises less than 10%, even less than 7.5% by weight of compound(s) having a cLogP of less than 2.1, relative to the total weight of said perfuming agent. In one embodiment, the perfuming agent does not comprise any compound having a cLogP of less than 2.1.

### Solid Shell

In one embodiment, the above-mentioned solid microcapsules comprise a solid shell entirely composed of crosslinked polymer such as defined above.

The above-mentioned solid shell is formed of a crosslinked polymer obtained by polymerization of at least one monomer or polymer bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions.

In the invention, the term «monomer» or «polymer» designates any basic unit adapted for the formation of a solid material via polymerization, either alone or in combination with other monomers or polymers. The term «polymer» also encompasses oligomers.

In one embodiment, the crosslinked polymer is obtained by polymerization of a monomer or polymer selected from among aliphatic or aromatic esters or polyesters, urethanes or polyurethanes, anhydrides or polyanhydrides, saccharides or polysaccharides, ethers or polyethers, amides or polyamides, and carbonates or polycarbonates, said monomers or polymers also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions.

Among the examples of said monomers or polymers mention can be made of the following compounds, but not limited thereto, and the mixtures thereof:
the family of aliphatic or aromatic esters and polyesters particularly comprising polyglycolides (PGA), polylactides (PLA), poly(lactide-co-glycolide) (PLGA), poly(ortho esters) e.g. polycaprolactone (PCL), polydiaxanone, poly(ethylene succinate), poly(butylene succinate) (PBS), le poly(ethylene adipate), poly(butylene adipate), poly(ethylene sebacate), poly(butylene sebacate), poly(valero lactone) (PVL), poly(decalactone), polyhydroxyvalerate, poly(beta-malic acid), poly-3-hydroxybutyrate (PHB), poly-3-hydroxy-butyrate-co-3-hydroxyvalerate (P-3HB-3HV), poly-3-hydroxybutyrate-co-4-hydroxybutyrate (P-3HB-4HB), poly-3-hydroxybutyrate-co-3-hydroxyvalerate-co-4-hydroxybutyrate (P-3HB-3HV-4HB), poly(3-hydroxy valerate), poly(3-hydroxypropionate), poly(3-hydroxycaproate), poly(3-hydroxyoctanoate), poly(3-hydroxydecanoate), poly (3-hydroxyundecanoate), poly(3-hydroxydodecanoate), poly(3-hydroxybutyrate-co-3-hydroxy valerate), poly(3-hydroxybutyrate-co-3-hydroxydecanoate), poly(3-hydroxybutyrate-co-3-hydroxypropionate), poly(3-hydroxybutyrate-co-3-hydroxyoctanoate), poly(3-hydroxyheptanoate), poly(3-hydroxyhexanoate), poly(2-hydroxybutyrate), poly(3-hydroxybutyrate-co-4-hydroxybutyrate), poly(3-hydroxybutyrate-co-3-hydroxyhexanoate), poly(3-hydroxybutyrate-co-3-hydroxyhexanoate), poly(4-hydroxybutyrate), poly(4-hydroxybutyrate-co-2-hydroxybutyrate), poly(4-hydroxypropionate), poly(4-hydroxyvalerate), poly(5-hydroxybutyrate), poly(5-hydroxyvalerate), poly(6-hydroxyhexanoate), poly(alkylene alkanoate), poly(alkylene dicarboxylate), poly(butylene adipate), poly(butylene adipate-co-terephthalate), poly(butylene carbonate), poly(butylene pimelate), poly(butylene succinate), poly(butylene succinate-co-adipate), poly(butylene succinate-co-carbonate), poly(butylene sebacate), poly(butylene sebacate-co-terephthalate), poly(butylene succinate-co-terephthalate), poly(butylene succinate-co-lactate), poly(cyclohexene carbonate), polydiaxanone, poly(ethylene azelate), poly(ethylene carbonate), poly(ethylene decamethylate), poly(ethylene furanoate), poly(ethylene oxalate), poly(ethylene succinate), poly(ethylene succinate-co-adipate), poly(ethylene sebacate), poly(ethylene succinate-co-terephthalate), poly(ethylene suberate), poly(hexamethylene sebacate), poly(glycolide-co-caprolactone), poly(lactide-co-epsilon-caprolactone), polymandelide, poly(B-malic acid), poly(b-propiolactone), poly(propylene succinate), poly(tetramethylene adipate-co-terephthalate), poly(tetramethylene carbonate), poly(trimethylene carbonate), poly(tetramethylene succinate)-co-(tetramethylene carbonate), poly(trimethylene adipate), poly(methylene adipate-co-terephthalate), poly(tetramethylene adipate), poly(tetramethyl glycolide), poly(butylene succinate), poly(valero lactone), also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions;
the family of anhydrides or polyanhydrides such as those derived from poly(sebacic acid), from polyadipic acid, from polyterephthalic acid, from poly(bis(p-carboxyphenoxy)alkane acid, or more broadly from the polyanhydrides described for example in Advanced Drug Delivery Reviews 54 (2002) 889-910, also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions;
the family of saccharides and polysaccharides, particularly comprising carrageenans, dextrans, cyclodextrins, e.g. hyaluronic acid, agarose, chitosan, chitin, alginate, starch, cellulose and derivatives thereof such as methyl cellulose, ethyl cellulose, hydroxyethyl cellulose, methylhydroxyethyl cellulose, ethylhydroxyethyl cellulose, carboxymethyl cellulose, hydroxypropyl cellulose or methylhydroxypropyl cellulose, also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions;
the family of ethers and polyethers, particularly comprising polyethylene glycols, also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions; and
the family of amides and polyamides, particularly comprising poly(ester amides) or polyphthalamide, also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions;
the family of polyurethanes, particularly comprising the reaction products of polyols with polyisocyanates, said reaction products also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions. Among the above-mentioned polyols, mention can be made of 1,4-butanediol, 1,2-propanediol, hexanediol, neopentyl glycol, diethylene glycol, dipropylene glycol, methylpropanediol, bisphenol A, polyoxypropylene diol, polybutadiene diol, oxytetramethylene glycol, ethylene glycol adipate diol, polyethylene adipate glycol propylene glycol diol, polyadipate diethylene glycol diol, polyethylene adipate-diethylene glycol ester diol, pentaerythritol, glycerol, trimethylolpropane, trishydroxyethylpropane, or oxypropylène triol. Among the above-mentioned polyisocyanates, mention can be made of the derivatives of hexamethylene diisocyanate, the derivatives of methylene dicyclohexyl diisocyanate, or the derivatives of isophorone diisocyanate.

In one preferred embodiment, the crosslinked polymer is selected from the group consisting of crosslinked polyesters, crosslinked polyepoxides and crosslinked polyurethanes.

Preferably, the crosslinked polymer shell of the solid microcapsules is obtained by polymerization of a composition C2 comprising at least one monomer or polymer bearing at least one reactive function such as defined above, at least one crosslinking agent and optionally at least one crosslinking photoinitiator or catalyst.

By «crosslinking agent», it is meant a compound carrying at least one two reactive functions able to crosslink a monomer or polymer, or mixture of monomers or polymers at the time of polymerization.

The crosslinking agent can be selected from among molecules carrying at least two same or different functions selected from the group consisting of acrylate, methacrylate, vinyl ether, N-vinyl ether, vinyl ester, thiolene, maleate, epoxy, siloxane, amine, lactone, phosphate and carboxylate functions.

As crosslinking agent particular mention is made of:
diacrylates, such as 1,6-hexanediol diacrylate, 1,6-hexanediol dimethacrylate, polyethylene glycol diacrylate, polyethylene glycol dimethacrylate, 1,9-nonanediol dimethacrylate, 1,4-butanediol dimethacrylate, 1,3-butanediol dimethacrylate, 1,10-decanediol dimethacrylate, bis (2-methacryloxyethyl) N,N′-1,9-nonylene biscarbamate, 1,4-butanediol diacrylate, 1,5-pentanediol dimethacrylate, allyl methacrylate, N,N′-methylenebisacrylamide, 2,2-bis[4-(2-hydroxy-3-methacryloxypropoxy) phenyl]propane, tetraethylene glycol diacrylate, diethylene glycol diacrylate, triethylene glycol diacrylate, triethylene glycol dimethacrylate, polyethylene glycol diglycidyl ether, N,N-diallylacrylamide or glycidyl methacrylate;
multi-functional acrylates such as dipentaerythritol pentaacrylate, 1,1,1-trimethylolpropane triacrylate, 1,1,1-trimethylolpropane trimethacrylate, ethylenediamine tetramethacrylate, pentaerythritol triacrylate or pentaerythritol tetraacrylate; and
acrylates also having another reactive function such as propargyl methacrylate, N-acryloxysuccinimide, N-(2-Hydroxypropyl)methacrylamide, N-(t-BOC-aminopropyl) methacrylamide, monoacryloxyethyl phosphate, acrylic anhydride, 2-(tert-butylamino)ethyl methacrylate, N,N-diallylacrylamide or glycidyl methacrylate.

By «photoinitiator», it is meant a compound capable of fragmenting under the effect of light radiation.

The photoinitiators able to be used in the present invention are known in the prior art and are described for example in “Les photoinitiateurs dans la réticulation des revêtements”, G. Li Bassi, Double Liaison—Chimie des Peintures, n°361, novembre 1985, p.34-41; “Applications industrielles de la polymerisation photoinduite”, Henri Strub, L′Actualité Chimique, février 2000, p.5-13; and “Photopolymères: considérations théoriques et réaction de prise”, Marc, J.M. Abadie, Double Liaison—Chimie des Peintures, n°435-436, 1992, p.28-34.

These photoinitiators encompass:
α-hydroxyketones, such as 2-hydroxy-2-methyl-1-phenyl-1-propanone, marketed for example under the trade names DAROCUR® 1173 and 4265, IRGACURE® 184, 2959, and 500 by BASF, and ADDITOL® CPK by CYTEC;

α-aminoketones, in particular 2-benzyl-2-dimethylamino-1-(4-morpholinophenyl)-butanone-1, marketed for example under the trade names IRGACURE® 907 and 369 by BASF;
aromatic ketones marketed for example under the trade name ESACURE® TZT by LAMBERTI; or thioxanthones marketed for example under the trade name ESACURE® ITX by LAMBERTI, and quinones. These aromatic ketones most often require the presence of a hydrogen donor compound such as tertiary amines and in particular alkanolamines. Particular mention can be made of the tertiary amine ESACURE® EDB marketed by LAMBERTI.
α-dicarbonyl derivatives of which the most widespread representative is benzyl dimethyl ketal marketed under the trade name IRGACURE® 651 by BASF. Other commercial products are marketed by LAMBERTI under the trade name ESACURE® KB1; and
acylphosphine oxides e.g. bis-acylphosphine oxides (BAPO) marketed for example under the trade names IRGACURE® 819, 1700, and 1800, DAROCUR® 4265, LUCIRIN® TPO, and LUCIRIN® TPO-L by BASF.

Among the photoinitiators, mention can also be made of aromatic ketones such as benzophenone, phenylglyoxylates e.g. the methyl ester of phenyl glyoxylic acid, oxime esters such as [1-(4-phenylsulfanylbenzoyl)heptylideneamino]benzoate, sulfonium salts, iodonium salts and oxime sulfonates.

### Preparation of the Microcapsules

In one embodiment, the solid microcapsules are obtained with a method comprising the following steps:
a) adding, under agitation, a composition C1 such as defined above to a polymeric composition C2, compositions C1 and C2 not being miscible with each other, the viscosity of composition C2 being between 500 mPa.s and
   100 000 mPa.s at 25° C., and preferably being greater than the viscosity of composition C1,
   composition C2 comprising:
      at least one monomer or polymer bearing at least one reactive function such as defined above,
   at least one crosslinking agent, and
   optionally at least one crosslinking photoinitiator or catalyst, after which an emulsion (E1) is obtained comprising droplets of composition C1 dispersed in composition C2;
b) adding, under agitation, emulsion (E1) to a composition C3, the compositions C2 and C3 not being miscible with each other, the viscosity of composition C3 being between 500 mPa.s and 100 000 mPa.s at 25° C., and preferably being greater than the viscosity of emulsion (E1), after which a double emulsion (E2) is obtained comprising droplets dispersed in composition C3;
c) applying shear to emulsion (E2), after which a double emulsion (E3) is obtained comprising droplets of controlled size dispersed in composition C3; and
d) polymerizing composition C2, after which solid microcapsules are obtained dispersed in composition C3.

The above-mentioned method consists of forming a double emulsion composed of droplets containing at least one perfuming agent enclosed by a crosslinkable liquid phase. These double droplets are then made monodisperse in size before being converted by crosslinking or polymerization into rigid capsules. The preparation involves 4 steps described in detail below.

In one embodiment, the method of the invention comprises a preliminary step before above-mentioned step a) to prepare composition C1 in the form of an emulsion.

At this step, a composition c1 comprising a perfuming agent is added to a hydrophilic composition c2, this step being conducted under agitation, which means that composition C1 is typically under mechanical agitation whilst composition c1 comprising the perfuming agent is added, to emulsify the mixture of composition C1.

At this step, composition c1 comprising the perfuming agent is at a temperature of between 0° C. and 100° C., preferably between 10° C. and 80° C., and more preferably between 15° C. and 60° C. At this step, the hydrophilic composition c2 is at a temperature of between 0° C. and 100° C., preferably between 10° C. and 80° C., and more preferably between 15° C. and 60° C.

To implement this step, any type of agitator usually employed to form emulsions can be used e.g. a mechanical blade agitator, static emulsifier, ultrasonic homogenizer, membrane homogenizer, high-pressure homogenizer, colloidal mill, high-shear disperser or high-speed homogenizer.

In one embodiment, the hydrophilic composition c2 contains a gelling agent.

In another embodiment, a gelling agent is added to composition C1 once composition c1 containing the perfuming agent has been emulsified in the hydrophilic composition c2. In this embodiment, to add the gelling agent to composition C1, any type of agitator employed to homogenize a solution can be used e.g. a mechanical blade agitator at slow rotation speed.

Step a) of the method of the invention consists of preparing a first emulsion (E1).

The first emulsion is a dispersion of droplets of composition C1 (containing at least one perfuming agent) in a polymeric composition C2 immiscible with C1, obtained by dropwise addition of C1 to C2 under agitation.

At step a), composition C1 is added to a crosslinkable polymeric composition C2, this step being conducted under agitation, which means that composition C2 is agitated typically mechanically whilst composition C1 is added, to emulsify the mixture of compositions C1 and C2.

The addition of composition C1 to composition C2 is typically performed dropwise.

At step a), composition C1 is at a temperature of between 0° C. and 100° C., preferably between 10° C. and 80° C., and more preferably between 15° C. and 60° C. At step a), composition C2 is at a temperature of between 0° C. and 100° C., preferably between 10° C. and 80° C., and more preferably between 15° C. and 60° C.

Under the addition conditions of step a), compositions C1 and C2 are not miscible with each other, which means that the quantity (by weight) of composition C1 able to be solubilized in composition C2 is less than or equal to 5%, preferably less than 1%, and more preferably less than 0.5%, relative to the total weight of composition C2, and that the quantity (by weight) of composition C2 able to be solubilized in composition C1 is less than or equal to 5%, preferably less than 1%, and more preferably less than 0.5% relative to the total weight of composition C1.

Therefore, when composition C1 comes into contact with composition C2 under agitation, it is dispersed in the form of droplets called single droplets.

The immiscibility between compositions C1 and C2 also allows prevented migration of the active ingredient from composition C1 towards composition C2.

Composition C2 is agitated to form an emulsion comprising droplets of composition C1 dispersed in composition C2. This emulsion is also called a «single emulsion» or C1-in-C2 emulsion.

To implement step a), any type of agitator usually employed to form emulsions can be used, e.g. a mechanical blade agitator, static emulsifier, ultrasonic homogenizer, membrane homogenizer, high-pressure homogenizer, colloidal mill, high-shear disperser or high-speed homogenizer

Composition C2 is intended to form the future solid shell of the microcapsules.

The volume fraction of C1 in C2 can vary from 0.1 to 0.6, to control the thickness of the shell of the capsules obtained on completion of the method.

In one embodiment, the ratio between the volume of composition C1 and the volume of composition C2 varies between 1:10 and 10:1. Preferably, this ratio is between 1:3 and 5:1, more preferably between 1:3 and 3:1.

Preferably, the viscosity of composition C2 at 25° C. is between 1 000 mPa.s and 50 000 mPa.s, more preferably between 2 000 mPa.s and 25 000 mPa.s, and for example between 3 000 mPa.s and 15 000 mPa.s.

Preferably, the viscosity of composition C2 is greater than the viscosity of composition C1.

Viscosity is measured using a Haake Rheostress™ 600 rheometer equipped with a cone of 60 mm diameter and angle of 2 degrees, having a temperature-control cell set at 25° C. The value of viscosity is read off at a shear rate of 10 s⁻¹.

In this embodiment, the destabilization kinetics of the droplets of emulsion (E1) are significantly low, which allows the shell of the microcapsules to be polymerized at step d) before the emulsion becomes destabilized. Polymerization, once completed, then provides thermodynamic stabilization. The relatively high viscosity of composition C2 therefore ensures the stability of emulsion (E1) obtained after step a).

Preferably, interfacial tension between compositions C1 and C2 is low. Typically, these interfacial tensions vary between 0 mN/m and 50 mN/m, preferably between 0 mN/m and 20 mN/m.

The low interfacial tension between compositions C1 and C2 also advantageously allows ensured stability of emulsion (E1) obtained after step a).

Composition C2 contains at least one monomer or polymer such as defined above, at least one crosslinking agent such as defined above, and optionally at least one crosslinking photoinitiator or catalyst such as defined above, making the composition crosslinkable.

In one embodiment, composition C2 comprises from 50 to 99 weight % of monomer or polymer such as defined above, or a mixture of monomers or polymers such as defined above, relative to the total weight of composition C2.

In one embodiment, composition C2 comprises from 1 to 20 weight % of crosslinking agent or mixture of crosslinking agents such as defined above, relative to the total weight of composition C2.

In one embodiment, composition C2 comprises from 0.1 to 5 weight % of photoinitiator or mixture of photoinitiators such as defined above, relative to the total weight of composition C2.

In one embodiment, composition C2 comprises from 0.001 to 20 weight % of crosslinking agent(s) relative to the total weight of said composition.

In one embodiment, composition C2 can also comprise an additional monomer or polymer able to improve the properties of the shell of the microcapsules and/or to impart new properties to the shell of the microcapsules.

Among these additional monomers or polymers, mention can be made of monomers or polymers carrying a group sensitive to pH, to temperature, to UV or to IR.

These additional monomers or polymers can induce rupture of the solid microcapsules and hence release of the content thereof, after stimulation e.g. via pH, temperature, UV or IR.

These additional monomers or polymers can be selected from among monomers or polymers carrying at least one of the following groups:
a pH-sensitive group such as primary, secondary or tertiary amines; carboxylic acids; phosphate, sulfate, nitrate or carbonate groups;
a UV-sensitive or UV-cleavable group (or photochromic group) such as azobenzene, spiropyran, 2-diazo-1,2-naphthoquinone, o-nitrobenzyl, thiol or 6-nitro-veratroyloxycarbonyl groups, for example poly(ethylene oxide)-block-poly(2-nitrobenzyl methacrylate), and other block copolymers such as described in particular in Liu et al., Polymer Chemistry 2013, 4, 3431-3443;
an IR-sensitive or IR-cleavable group such as o-nitrobenzyl or 2-diazo-1,2-naphthoquinone, for example the polymers described in Liu et al., Polymer Chemistry 2013, 4, 3431-3443;
a hydrolysis-sensitive group such as poly(lactic acid), poly(glycolic acid), poly(lactic-co-glycolic acid), polycaprolactone, polyhydroxybutyrate, chitosan, dextran, agarose, cellulose and derivatives of these compounds; and
a temperature-sensitive group such as poly(N-isopropylacrylamide).

Step b) of the method of the invention consists of preparing a second emulsion (E2).

The second emulsion is a dispersion of droplets of the first emulsion in a composition C3 immiscible with C2, obtained by dropwise addition of emulsion (E1) to C3 under agitation.

At step b), emulsion (E1) is at a temperature of between 15° C. and 60° C. At step b), composition C3 is at a temperature of between 15° C. and 60° C.

Under the addition conditions of step b), compositions C2 and C3 are not miscible with each other, which means that the quantity (by weight) of composition C2 able to be solubilized in composition C3 is less than or equal to 5%, preferably less than 1%, and more preferably less than 0.5% relative to the total weight of composition C3, and that the quantity (by weight) of composition C3 able to be solubilized in composition C2 is less than or equal to 5%, preferably less than 1%, and more preferably less than 0.5% relative to the total weight of composition C2.

Therefore, when emulsion (E1) comes into contact with composition C3 under agitation, it is dispersed in the form of droplets called double droplets, the dispersion of these droplets of emulsion (E1) in the continuous phase C3 being called emulsion (E2).

Typically, a double droplet formed at step b) corresponds to a single droplet of composition C1 such as described above, surrounded by a shell of composition C2 which fully encapsulates said single droplet.

The double droplet formed at step b) can also comprise at least two single droplets of composition C1, said single droplets being surrounded by a shell of composition C2 which fully encapsulates said single droplets.

Therefore, said double droplets comprise a core composed of one of more single droplets of composition C1, and a layer of composition C2 surrounding said core.

The resulting emulsion (E2) is generally a polydisperse double emulsion (emulsion C1-in-C2-in-C3 or C1/C2/C3 emulsion), which means that the double droplets do not have a distinct size distribution in emulsion (E2).

The immiscibility between compositions C2 and C3 prevents mixing between the layer of composition C2 and composition C3, thereby ensuring the stability of emulsion (E2).

The immiscibility between compositions C2 and C3 also prevents the water-soluble substance of composition C1 from migrating from the core of the droplets towards composition C3.

To implement step b), it is possible to use any type of agitator usually used to form emulsions e.g. a mechanical blade agitator, static emulsifier, ultrasonic homogenizer, membrane homogenizer, high-pressure homogenizer, colloidal mill, high-shear disperser or high-speed homogenizer.

In one embodiment, the viscosity of composition C3 at 25° C. is greater than the viscosity of emulsion (E1) at 25° C.

In the invention, the viscosity of composition C3 at 25° C. is between 500 mPa.s and 100 000 mPa.s.

Preferably, the viscosity of composition C3 at 25° C. is between 3 000 mPa.s and 100 000 mPa.s, more preferably between 5 000 mPa.s and 80 000 mPa.s, for example between 7 000 mPa.s and 70 000 mPa.s.

In this embodiment, given the very high viscosity of the continuous phase formed by composition C3, the destabilization kinetics of the double droplets of emulsion (E2) are significantly slow in relation to the time length of the method of the invention, which therefore provides kinetic stabilization of emulsion (E2) then of emulsion (E3) until polymerization of the shell of the capsules has been completed. Once polymerized, the capsules are thermodynamically stable.

Therefore, the very high viscosity of composition C3 ensures the stability of emulsion (E2) obtained after step b).

Low surface tension between C3 and the first emulsion, and the high viscosity of the system, advantageously allow ensured kinetic stability of the double emulsion (E2), preventing dephasing thereof throughout the production process.

Preferably, the interfacial tension between compositions C2 and C3 is low. The low interfacial tension between compositions C2 and C3 also advantageously allows ensured stability of emulsion (E2) obtained after step b).

The volume fraction of the first emulsion in C3 can be varied from 0.05 to 0.5 both to improve production yield and to vary the mean diameter of the capsules. At the end of this step, the size distribution in the second emulsion is relatively wide.

In one embodiment, the ratio between the volume of emulsion (E1) and the volume of composition C3 varies between 1:10 and 10:1. Preferably, this ratio is between 1:9 and 3:1, preferably between 1:9 et 1:1.

In one embodiment, composition C3 also comprises at least one branched polymer preferably having a molecular weight higher than 5 000 g.mol⁻¹, and/or at least one polymer having a molecular weight higher than 5 000 g.mol⁻¹, and/or solid particles such as silicates.

In one embodiment, composition C3 comprises at least one branched polymer, preferably having a molecular weight higher than 5 000 g.mol⁻¹, more preferably between 10 000 g.mol⁻¹ and 500 000 g.mol⁻¹, for example between 50 000 g.mol⁻¹ and 300 000 g.mol⁻¹.

By «branched polymer» it is meant a polymer having at least one branch point between its two terminal groups, a branch point being a point on a chain at which a side chain is attached also called a branch or pendant chain.

Among branched polymers, mention can be made for example of graft, comb or star polymers, or dendrimers.

In one embodiment, composition C3 comprises at least one polymer of molecular weight higher than 5 000 g.mol⁻¹, preferably between 10 000 g.mol⁻¹ and 500 000 g.mol⁻¹, for example between 50 000 g.mol⁻¹ and 300 000 g.mol⁻¹.

As polymer able to be used in composition C3, the following compounds can be cited, used alone or in a mixture thereof:
cellulose derivatives, such as ethers of cellulose: methyl cellulose, ethyl cellulose, hydroxyethyl cellulose, methylhydroxyethyl cellulose, ethylhydroxyethyl cellulose, carboxymethyl cellulose, hydroxypropyl cellulose or methylhydroxypropyl cellulose;
polyacrylates (also called carbomers), such as polyacrylic acid (PAA), polymethacrylic acid (PMAA), poly(hydroxyethyl methacrylate) (pHEMA), poly(N-2-hydroxypropyl methacrylate) (pHPMA);
polyacrylamides such as poly(N-isopropylacrylamide) (PNIPAM);
polyvinylpyrrolidone (PVP) and derivatives thereof;
polyvinyl alcohol (PVA) and derivatives thereof;
poly(ethylene glycol), poly(propylene glycol) and derivatives thereof such as poly(ethylene glycol) acrylate/methacrylate, poly(ethylene glycol) diacrylate/dimethacrylate, polypropylene carbonate;
polysaccharides such as carrageenans, locust bean gum or tara gum, dextran, xanthan gums, chitosan, agarose, hyaluronic acids, gellan gum, guar gum, gum arabica, gum tragacanth, diutan gum, oat gum, karaya gum, ghatti gum, curdlan gum, pectin, konjac gum, starch;
protein derivatives such as gelatine, collagen, fibrin, polylysine, albumin, casein;
derivatives of silicone such as polydimethylsiloxane (also called dimethicone), alkyl silicones, aryl silicones, alkyl aryl silicones, polyethylene glycol dimethicones, polypropylene glycol dimethicones;
waxes, such as diester waxes (diesters of alkanediol, diesters of hydroxyl acids), triester waxes (triacylglycerols, triesters of alkane-1,2-diol, w-hydroxy acid and fatty acid, esters of hydroxymalonic acid, fatty acid and alcohol, triesters of hydroxylacids, fatty acid and fatty alcohol, triesters of fatty acid, hydroxylacid and diol) and polyester waxes (polyesters of fatty acids). The fatty acid esters able to be used as waxes in the invention are for example cetyl palmitate, cetyl octanoate, cetyl laurate, cetyl lactate, cetyl isononanoate, cetyl stearate, stearyl stearate, myristyl stearate, cetyl myristate, isocetyl stearate, glyceryl trimyristate, glyceryl tripalmitate, glyceryl monostearate or glyceryl and cetyl palmitate;
the fatty acids able to be used as waxes are for example cerotic acid, palmitic acid, stearic acid, dihydroxystearic acid, behenic acid, lignoceric acid, arachidic acid, myristic acid, lauric acid, tridecylic acid, pentadecylic acid, margaric acid, nonadecylic acid, heneicosylic acid, tricosylic acid, pentacosanoic acid, heptacosanoic acid, montanic acid or nonacosanoic acid;
fatty acid salts, in particular fatty acid aluminum salts such as aluminum stearate, hydroxyl aluminum bis (2-ethylhexanoate);
isomerized jojoba oil;
hydrogenated sunflower seed oil;
hydrogenated copra oil;
hydrogenated lanolin oil;
castor oil and derivatives thereof, in particular modified hydrogenated castor oil or the compounds obtained by esterification of castor oil with fatty alcohols;
polyurethanes and derivatives thereof;
styrenic polymers such as styrene butadiene; and
polyolefins such as polyisobutene.

In one embodiment, composition C3 comprises solid particles such as clays, silicas and silicates.

As solid particles able to be used in composition C3, mention can be made of clays and silicates particularly belonging to the category of phyllosilicates (also called sheet silicas). As examples of silicates able to be used in the invention, mention can be made of Bentonite, Hectorite, Attapulgite, Sepiolite, Montmorillonite, Saponite, Sauconite, Nontronite, Kaolinite, Talc, Sepiolite, Chalk. Fumed synthetic silicas can also be used. The aforementioned clays, silicates and silicas can advantageously be modified by organic molecules such as polyethers, ethoxylated amides, quaternary ammonium salts, long chain diamines, long chain esters, polyethylene glycols, polypropylene glycols.

These particles can be used alone or in a mixture thereof.

In one embodiment, composition C3 comprises at least one polymer of molecular weight higher than 5 000 g.mol⁻¹ and solid particles. Any mixture of the afore-cited compounds can be used.

Step c) of the method of the invention consists of refining the size of the droplets of the second emulsion (E2).

This step can consist of applying controlled, homogeneous shear to emulsion (E2), the applied shear rate being between 10 s⁻¹ and 100 000 s⁻¹.

In one embodiment, the polydisperse double droplets obtained at step b) are subjected to size refining whereby they undergo shear capable of fragmenting them into new double droplets of controlled, homogenous diameters. Preferably, this fragmentation step is performed using a high-shear cell of Couette type following a method described in patent application EP 15 306 428.2.

In one embodiment, at step c), the second emulsion (E2) obtained after step b), consisting of polydisperse double droplets dispersed in a continuous phase, is subjected to shear in a mixer which applies controlled, homogeneous shear.

Therefore, in this embodiment, step c) consists of applying controlled, homogeneous shear to emulsion (E2), said applied shear rate being between 1 000 s⁻¹ and 100 000 s⁻¹.

In this embodiment, in a mixer, the shear rate is said to be controlled and homogeneous, independently of time length, when it reaches a maximum value that is the same for all the parts of the emulsion, at a given time which can vary from one point of the emulsion to another. The exact configuration of the mixer is not essential in the invention provided that the whole emulsion has been subjected to the same maximum shear when output from this device. Mixers suitable for performing step c) are described in particular in document US 5 938 581.

The second emulsion can undergo controlled, homogeneous shear when it circulates through a cell formed by:
two concentric rotating cylinders (also called mixer of Couette type);
two parallel rotating discs; or
two parallel oscillating plates.

In this embodiment, the shear rate applied to the second emulsion is between 1 000 s⁻¹ and 100 000 s-1, preferably between 1 000 s⁻¹ and 50 000 s⁻¹, and more preferably between 2 000 s⁻¹ and 20 000 s⁻¹.

In this embodiment, at step c), the second emulsion is input into the mixer and subjected to shear which results in the formation of the third emulsion. The third emulsion (E3) is chemically identical to the second emulsion (E2) but consists of monodisperse double droplets whereas emulsion (E2) consists of polydisperse double droplets. The third emulsion (E3) typically consists of a dispersion of double droplets comprising a core composed of one of more droplets of composition C1 and a layer of composition C2 encapsulating said core, said double droplets being dispersed in composition C3.

The difference between the second emulsion and the third emulsion is the size variance of the double droplets: the droplets of the second emulsion are polydisperse in size whereas the droplets of the third emulsion are monodisperse, by means of the fragmenting mechanism described above.

Preferably, in this embodiment, the second emulsion is continuously added to the mixer, which means that the quantity of double emulsion (E2) input into the mixer is the same as the quantity of third emulsion (E3) output from the mixer.

Since the size of the droplets of emulsion (E3) essentially corresponds to the size of the droplets of the solid microcapsules after polymerization, it is possible to adjust the size of the microcapsules and the thickness of the shell by adjusting the shear rate at step c), with strong correlation between the decrease in size of the droplets and the increase in shear rate. This allows adjustment of the resulting dimensions of the microcapsules by varying the shear rate applied at step c).

In one preferred embodiment, the mixer used at step c) is a mixer of Couette type comprising two concentric cylinders, an outer cylinder of inner radius Rₒ and an inner cylinder of outer radius Rᵢ, the outer cylinder being fixed and the inner cylinder being rotated at an angular velocity ω.

A mixer of Couette type adapted for the method of the invention can be supplied by T.S.R. France.

In one embodiment, the angular velocity ω of the inner rotating cylinder of the Couette-type mixer is greater than or equal to 30 rad.s⁻¹.

For example, the angular velocity w of the inner rotating cylinder of the Couette-type mixer is about 70 rad.s⁻¹.

The dimensions of the outer fixed cylinder of the Couette-type mixer can be chosen to modulate the space (d=Rₒ−Rᵢ) between the inner rotating cylinder and the outer fixed cylinder.

In one embodiment, the space (d=Rₒ—Rᵢ) between the two concentric cylinders of the Couette-type mixer is between 50 μm and 1 000 μm, preferably between 100 μm and 500 μm, for example between 200 μm and 400 μm.

For example, the distance d between the two concentric cylinders is 100 μm.

In this embodiment, at step c), the second emulsion is input into the mixer, typically via a pump, and is directed towards the space between the two concentric cylinders, the outer cylinder being fixed and the inner cylinder rotating at an angular velocity ω.

When the double emulsion lies in the space between the two cylinders, the shear rate applied to said emulsion is given by the following equation:

γ=_{(R}_{ₒ}_{-R}_{ᵢ}₎^{R}^{ᵢ}^{ω}

where:
ω is the angular velocity of the inner rotating cylinder;
-Rₒ is the inner radius of the outer fixed cylinder; and
Rᵢ is the outer radius of the inner rotating cylinder.

In another embodiment, when the viscosity of composition C3 is greater than 2 000 mPa.s at 25° C., step c) consists of applying to emulsion (E2) a shear rate that is lower than 1 000 s⁻¹.

In this embodiment, the fragmenting step c) can be conducted using any type of mixer usually used to form emulsions at a shear rate lower than 1 000 s⁻¹, in which case the viscosity of composition C3 is greater than 2 000 mPa.s, namely under conditions such as those described in patent application FR 16 61787.

The geometric characteristics of the double drops formed at the end of this step will dictate those of the future capsules.

In this embodiment, at step c), emulsion (E2), composed of polydisperse droplets dispersed in a continuous phase, is subjected to shear e.g. in a mixer at low shear rate namely lower than 1 000 s⁻¹.

In this embodiment, the shear rate applied at step c) is between 10 s⁻¹ and 1 000 s⁻¹ for example.

Preferably, the shear rate applied at step c) is strictly lower than 1 000 s⁻¹.

In this embodiment, the droplets of emulsion (E2) can only be efficiently fragmented into fine monodisperse droplets of emulsion (E3) if a high shear stress is applied thereto.

The shear stress o applied to a droplet of emulsion (E2) is defined as the tangential force per unit droplet surface area resulting from the macroscopic shear applied to the emulsion under agitation at step d).

The shear stress o (expressed in Pa), the viscosity n of composition C3 (expressed in Pa s) and shear rate y (expressed in s⁻¹) applied to emulsion (E2) under agitation at step d) are related by the following equation:

σ=ηγ

Therefore, in this embodiment, the high viscosity of composition C3 allows very high shear stress to be applied to the droplets of emulsion (E2) in the mixer, even if the shear rate is low and shear is non-homogeneous.

To implement step c) in this embodiment, any type of agitator can be used usually employed for forming emulsions e.g. a mechanical blade agitator, static emulsifier, ultrasonic homogenizer, membrane homogenizer, high-pressure homogenizer, colloidal mill, high-shear disperser or high-speed homogenizer.

In one preferred embodiment, a simple emulsifier is used such as a mechanical blade agitator or static emulsifier to perform step c). This is possible since this embodiment does not require either controlled shear or shear greater than 1 000 s⁻¹.

Step d) of the method of the invention consists of crosslinking and hence forming the shell of the solid microcapsules according to the invention.

This step allows both the expected retention performance of the capsules to be achieved and ensured thermodynamic stability thereof, by definitively preventing any destabilizing mechanism such as coalescence or maturation.

In one embodiment, when composition C2 comprises a photoinitiator, step d) is a photopolymerization step whereby emulsion (E3) is exposed to a light source able to initiate photopolymerization of composition C2, in particular to a UV light source preferably emitting in the wavelength range of between 100 nm and 400 nm, and in particular for a time of less than 15 minutes.

In this embodiment, step d) consists of subjecting emulsion (E3) to photopolymerization, which will allow photopolymerization of composition C2. This step will allow microcapsules to be obtained encapsulating the water-soluble substance such as defined above.

In one embodiment, step d) consists of exposing emulsion (E3) to a light source capable of initiating photopolymerization of composition C2.

Preferably, the light source is a UV light source.

In one embodiment, the UV light source emits in the wavelength range of between 100 nm and 400 nm.

In one embodiment, emulsion (E3) is exposed to a light source for a time of less than 15 minutes, and preferably for 5 to 10 minutes.

At step d), the shell of the above-mentioned double droplets, composed of photo-crosslinkable composition C2, is crosslinked and thereby converted to a viscoelastic polymeric shell encapsulating and protecting the water-soluble substance against release thereof in the absence of a mechanical trigger.

In another embodiment, when composition C2 does not comprise a photoinitiator, step d) is a polymerization step without exposure to a light source, the length of this polymerization step d) preferably being between 8 hours and 100 hours and/or this step d) is conducted at a temperature of between 20° C. and 80° C.

In this embodiment, polymerization is initiated for example by exposure to heat (thermal initiation) or via simple contacting between the monomers, polymers and crosslinking agents, or via a catalyst. Polymerization time is then generally longer than several hours.

Preferably, the polymerization step d) of composition C2 is conducted for a time of between 8 hours and 100 hours at a temperature of between 20° C. and 80° C.

The composition obtained after step d), comprising solid microcapsules dispersed in composition C3, is ready to use and can be employed without any additional post-treatment step of the capsules being required.

The thickness of the shell of the microcapsules thus obtained is typically between 0.1 μm and 20 μm, preferably between 0.2 μm and 8 μm, and more preferably between 0.2 μm and 5 μm.

In one embodiment, the solid microcapsules obtained after step d) are free of surfactant.

The method of the invention has the advantage of not requiring a surfactant in any of the described steps. The method of the invention therefore allows the reduced presence of additives which could modify the properties of the end product obtained after release of the perfuming agent.

The present invention also concerns the use of a composition such as defined above, for home cleaning.

The present invention also concerns the use of the microcapsules such as defined above to improve the olfactory and/or sensory properties of a composition for home cleaning.

The present invention also concerns the use of the microcapsules such as defined above to reduce, even prevent evaporation of the perfuming agent provided by the microcapsules.

The expressions « between . . . and . . . », «from . . . to . . . » and «ranging from . . . to . . . » are to be construed with the limits included, unless otherwise specified.

The following examples illustrate the present invention without limiting the scope thereof.

1. A composition comprising:
at least one composition for home care, and
at least one solid microcapsule having an average diameter of between 1 μm and 30 μm, comprising:
a core consisting of a composition C1 comprising at least one perfuming agent, said composition C1 being in emulsion form, and
a solid shell of crosslinked polymer totally encapsulating the core at its periphery, said solid shell comprising a crosslinked polymer obtained by polymerization of at least one monomer or polymer bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions,
and wherein the thickness of the solid shell is between 0.1 μm and 20 μm.

2. The composition according to claim 1, comprising an assembly of solid microcapsules, each of said solid microcapsules being such as defined in claim 1, and wherein the standard deviation of diameter size distribution of the microcapsules is less than 50%, or less than 1 μm.

3. The composition according to claim 1, wherein composition C1 of the core of the solid microcapsules comprises at least 20 weight % of perfuming agent relative to the total weight of said composition C1.

4. The composition according to claim 1, wherein composition C1 also comprises at least one aqueous gelling agent.

5. The composition according to claim 4, wherein composition C1 is in the form of an emulsion comprising a continuous phase in the form of an aqueous gel.

6. The composition according to claim 1, wherein the crosslinked polymer is obtained by polymerization of a monomer or polymer selected from among aliphatic or aromatic esters or polyesters, urethanes or polyurethanes, anhydrides or polyanhydrides, saccharides or polysaccharides, ethers or polyethers, amides or polyamides, and carbonates or polycarbonates, said monomers or polymers also bearing at least one reactive function selected from the group consisting of acrylate, methacrylate, vinyl ether, N-vinyl ether, vinyl ester, thiolene, maleate, epoxy, siloxane, amine, lactone, phosphate and carboxylate functions.

7. The composition according to claim 1, wherein the crosslinked polymer is selected from the group consisting of crosslinked polyesters, crosslinked polyepoxides and crosslinked polyurethanes.

8. The composition according to claim 1, wherein the crosslinked polymer of the shell of the solid microcapsules is obtained by polymerization of composition C2 comprising at least one monomer or polymer bearing at least one reactive function such as defined claim 1, at least one crosslinking agent and optionally at least one crosslinking photoinitiator or catalyst.

9. The composition according to claim 1, wherein the solid microcapsules are obtained with a method comprising the following steps:
a) adding, under stirring, composition C1 such as defined in claim 1, to a polymeric composition C2, compositions C1 and C2 not being miscible with each other,
the viscosity of composition C2 being between 500 mPa.s and 100 000 mPa.s at 25° C.,
composition C2 comprising:
at least one monomer or polymer bearing at least one reactive function such as defined in claim 1,
at least one crosslinking agent, and
optionally at least one crosslinking photoinitiator or catalyst,
after which an emulsion (E1) is obtained comprising droplets of composition C1 dispersed in composition C2;
b) adding, under stirring, emulsion (E1) to a composition C3, compositions C2 and C3 not being miscible with each other,
the viscosity of composition C3 being between 500 mPa.s and 100 000 mPa.s at 25° C.,
after which a double emulsion (E2) is obtained comprising droplets dispersed in composition C3;
c) applying shear to emulsion (E2), after which a double emulsion (E3) is obtained comprising droplets of controlled size dispersed in composition C3; and
d) polymerizing composition C2, after which solid microcapsules are obtained dispersed in composition C3.

10. The composition according to claim 4, wherein the aqueous gelling agent is selected from the group consisting of cellulose derivatives, polyacrylates, polyacrylamides, polyvinylpyrrolidone and derivatives thereof, polyvinyl alcohol and derivatives thereof, poly(ethylene glycol), poly(propylene glycol) and derivatives thereof, polysaccharides, protein derivatives, polyurethanes and derivatives thereof, clays and silicates.
